(19) United States
(12) Patent Application Publication
(10) Pub. No.: US 2012/0221700 A1
(43) Pub. Date: Aug. 30, 2012

(54) System, Method and Program for Telecom Infrastructure Virtualization and Management

(75) Inventors: Ashutosh Dutta, Bridgewater, NJ (US); Christian Makaya, New Brunswick, NJ (US); Dana Chee, Maplewood, NJ (US); Subir Das, Belle Mead, NJ (US); Benjamin Falchuk, Upper Nyack, NY (US); Surendran Alathurai, Monmouth Junction, NJ (US); Fuchun Joseph Lin, Morris Plains, NJ (US); Satoshi Komorita, Saitama (JP); Tsunehiko Chiba, Saitama (JP); Hidetoshi Yokota, Saitama (JP); Manabu Ito, Tokyo (JP)

(73) Assignees: KDDI CORPORATION, Chiyoda-ku (JP); TELCORDIA TECHNOLOGIES, INC., Piscataway, NJ (US)

(21) Appl. No.: 13/218,567

(22) Filed: Aug. 26, 2011

Related U.S. Application Data
(60) Provisional application No. 61/377,337, filed on Aug. 26, 2010.

(51) Int. Cl. G06F 15/173

(52) U.S. Cl. 709/223

(57) ABSTRACT

A virtualized telecom system and a method for managing service continuity and mobility in a virtualized telecom system. The system comprises a plurality of execution nodes each configured to execute a network function by registering; and a manager node for registering each of the plurality of execution nodes, assigning a node identifier (Node ID) to each of the plurality of execution nodes, periodically polling each of the plurality of execution nodes for a status, and issuing control instructions to each of the plurality of execution nodes based upon the status of a respective execution node. Each of the plurality of execution node responds to the polling by transmitting its status to the manager node. The status includes runtime information and pre-configuration information.

### CROSS-REFERENCE TO RELATED APPLICATION

This application claims the benefit of and priority to U.S. Provisional Application Ser. No. 61/377,337 filed Aug. 26, 2010 the entirety of which is incorporated herein by reference.

### FIELD OF THE INVENTION

This disclosure is related to the management of functional entities and server nodes of a network in a virtual environment. More particularly, the disclosure is related to a system, method and program for managing the functional entities and server nodes to support service continuity and mobility in the virtualized telecom environment and infrastructure, i.e., virtualized telecom system.

### BACKGROUND

The virtualization of telecom infrastructure (e.g., call control function or policy control function in IMS architecture) allows higher reliability and efficient resources usage. However, dynamic resources management, functional entities assignment and session persistence issues arise when telecom infrastructures are virtualized. It is important to maintain service mobility and continuity by overcome these issues.

In telecom networks, network entities are often tightly coupled with each others. For example, in IP Multimedia Subsystem (“IMS”) a session requires collaboration among Proxy Call Session Control Function (“P-CSCF”), Interrogating Call Session Control Function (“I-CSCF”), Home Subscriber Server (“HSS”) and Serving Call Session Control Function (“5-CSCF”) while in Evolved Packet Core (“EPC”), an IP connectivity requires close interactions among Mobility Management Entity (“MME”), Signaling Gateway (“S-GW”), and Packet Data Network Gateway (“P-GW”). This is different from the IT environment where the services are transaction-based and no coupling relations need to be maintained among network entities. In other words, the state and relationship between different network functional entities and end-users need to be maintained to guarantee service delivery. This imposes a challenging issue when a telecom infrastructure such as IMS or EPC is virtualized. In a virtual environment, functional entities and services nodes for telecom infrastructure can be dynamically created, assigned and moved. However, during these operations the original logical topology and relationship among network entities should be maintained to guarantee continuity and mobility of services.

U.S. patent application Ser. No. 13/023,893, assigned to Telcordia, describes Self Organizing IMS Network and Method for Organizing and Maintaining Sessions, the entirety of which is incorporate by reference.

### SUMMARY OF THE INVENTION

Accordingly, disclosed is network architecture, method, and program for enabling services continuity and mobility in the virtualized telecom system that may reside in a cloud environment.

Disclosed is a method for managing service continuity and mobility in a virtualized telecom system comprising receiving a registration request from an execution node, registering the execution node for a specified function, transmitting, periodically, a request for a status from the execution node, de-registering the execution node if a response to the request for a status is not received within a variable period of time and transmitting a control message to the execution node.

The control message includes an instruction to add, delete, and/or move a specified function. The specified function is identified by an identifier. The instruction to move includes an identifier of a source execution node and an identifier of a destination execution node. Status and runtime information corresponding to the specified function is transmitted from the source execution node to the destination execution node.

Additionally, the instruction can be to move a session from a source execution node to a destination execution node. The session dialog corresponding to the moved session is moved to the second execution node.

The method further comprises receiving message from the execution node when the execution node completes a function included in the control message.

The configuration and runtime information is received from the execution node in response to the request for a status report.

Also disclosed is a method for executing a function on an execution node comprising obtaining a network address for a management node, transmitting a registration request from an execution node, receiving a unique functional node identifier from the management node, receiving a control message including at least one instruction from the management node and executing the at least one instruction.

The method further comprises transmitting configuration and runtime information from the execution node in response to the request for a status.

Also disclosed is a virtualized telecom system comprising a plurality of execution nodes each configured to execute a network function by registering; and a manager node for registering each of the plurality of execution nodes, assigning a node identifier (Node ID) to each of the plurality of execution nodes, periodically polling each of the plurality of execution nodes for a status, and issuing control instructions to each of the plurality of execution nodes based upon the status of a respective execution node. Each of the plurality of execution node responds to the polling by transmitting its status to the manager node. The status includes runtime information and pre-configuration information.

Also disclosed is a computer readable storage medium having a program for causing a computer to execute the method of obtaining a network address for a management node, transmitting a registration request from an execution node, receiving a unique functional node identifier from the management node, receiving a control message including at least one instruction from the management node and executing the at least one instruction.

Also disclosed is a computer readable storage medium having a program for causing a computer to execute the method of receiving a registration request from a execution node, registering the execution node for a specified function, transmitting, periodically, a request for a status from the execution node, de-registering the execution node if a response to the request for a status is not received within a variable period of time and transmitting a control message to the execution node.

### BRIEF DESCRIPTION OF THE DRAWINGS

These and other features, benefits, and advantages of the present invention will become apparent by reference to the following figures, with like reference numbers referring to like structures across the views, wherein:

FIG. 1 illustrates an exemplary system in accordance with the invention;

FIG. 2 illustrates an exemplary message flow between a manager node and an execution node;

FIGS. 3A and 3B illustrate flow charts for the registration and initial monitoring of execution nodes in accordance with the invention, where FIG. 3A is directed to the execution node and FIG. 3B is directed to the manager node;

FIGS. 4A and 4B illustrate flow charts for function activation in execution node and continued monitoring in accordance with the invention, where FIG. 4A is directed to the execution node and FIG. 4B is directed to the manager node;

FIGS. 5A and 5B illustrate flow charts for issuing runtime operational commands and transmitting status updates in accordance with the invention, where FIG. 5A is directed to the execution node and FIG. 5B is directed to the manager node;

FIG. 6 illustrates an exemplary service mobility between execution nodes in accordance with the invention.

### DETAILED DESCRIPTION OF THE INVENTION

### Definitions

“Execution Node” is a logical entity that can execute function, such as a virtual machine.

“Manager Node” is a logical entity that manages functions running on the execution nodes. The Manager Node is in charge of synchronization of functions movement and preservation of network functional entities identification (e.g., IP addresses).

“Information Server” is a server used for discovery of Manager Node and Execution Node for example a Domain Name Server (DNS) or Dynamic Host Configuration Protocol (DHCP) server.

“Function” is a logical unit that provides a specific service such as call control or mobility. The function is executed by an execution node.

“Session” is a relationship between functions providing a specific service. Each function may maintain a state related to the session. Moreover, the active sessions usually maintain information about the IP addresses of functions (e.g., CSCFs, P-GW, MME), then those IP addresses need to be preserved during services mobility and network reconfiguration (e.g., virtual machine migration).

“Service mobility” is the capability to move function(s) among execution nodes while maintaining the ongoing services.

“Node ID” is an identifier that uniquely identifies the execution node, which is provided and managed by the manager node. The node ID is a separate and distinct identifier from the physical hardware (unit).

“Function ID” is an identifier that uniquely identifies the function, which is provided and managed by the manager node.

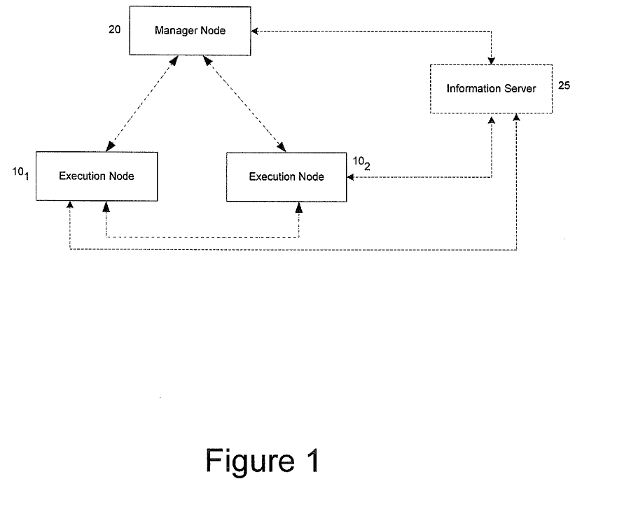

FIG. 1 illustrates an exemplary virtualized telecom system or architecture 1 (the “system”) with the ability to dynamically add, move and delete the functional components in accordance with the invention. For purposes of the description, system and architecture are used interchangeable. The system 1 includes at least one execution node (collectively referenced as “10”), a manager node 20 and an information server 25. The information server 25 is optional. The manager node 20 can be a centralized node or distributed in a peer-to-peer manner. The execution node 10 is a virtual machine on which target network functions can be allocated. The system 1 can be used in conjunction with network infrastructure, such as, but not limited to, an IMS, EPC or Service Delivery Platform (“SDP”). For example, in the context of IMS, the CSCF and HSS while for EPC, MME, S-GW and P-GW are candidates of such functions. The Information Server 25 can be, but is not limited to, DHCP and DNS server and is used for the discovery and assignment of execution node for a session.

The system 1 enables dynamic resource (re)allocation across services, dynamic configuration of the virtual networks, flexible network architecture and resource and services provisioning and management.

The execution node 10 or a group thereof (service unit) may move its physical or topological location from one execution node to other or from one physical hardware to another. This movement must be transparent to the service user, i.e., the on-going service must be continued seamlessly and the existing protocols and interfaces should not be affected by this capability. An execution node 10 can run on one physical hardware unit (e.g., server machine) or on multiple hardware units. Functions run on the execution nodes 10. When functions and/or sessions move from one execution node 10 to another, consistency in the status information must be maintained to continue the sessions. In fact, the active sessions usually maintain information about the IP addresses of functions (e.g., CSCFs, P-GW, MME), then those IP addresses (as it appears from the outside) need to be preserved during services mobility and network reconfiguration (e.g., virtual machine migration). If several functions are related, it is important to have a sort of synchronization between functions and network entities. Therefore, the manager node 20 maintains the consistent information for the session(s) and the status information of functions as well as the execution node 10.

The manager node 20 communicates with the execution nodes 10 to control the mobility of functions or services and to control the execution node 10. The manager node 20 can be deployed in a centralized or distributed approach; however, that must be transparent to the execution nodes 10. The execution nodes 10 communicate with each other to move functions between the nodes. An information server 25 is provided for the manager node 20 and execution nodes 10 to discover each other.

The manager node 20 enables service mobility for the session where execution nodes 10 and functions within the execution nodes 10 can be dynamically added, deleted, re-allocated (for load balancing) and moved.

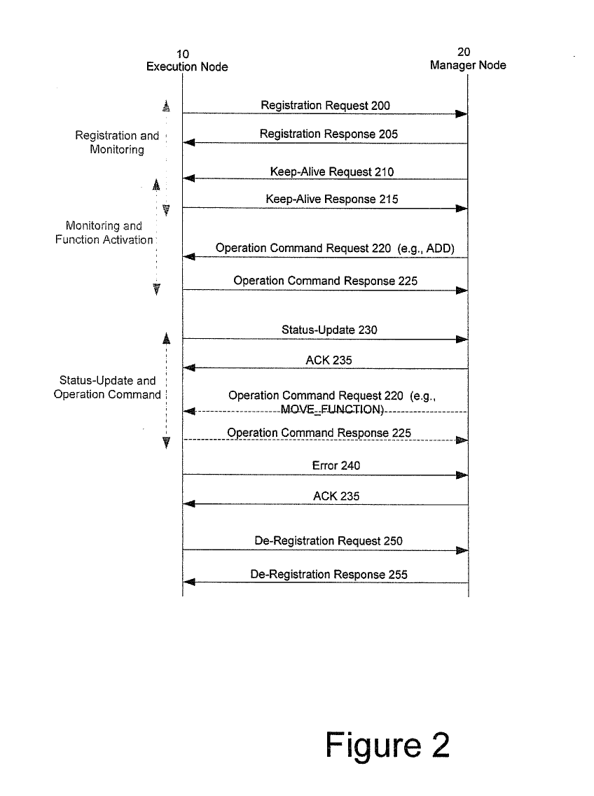

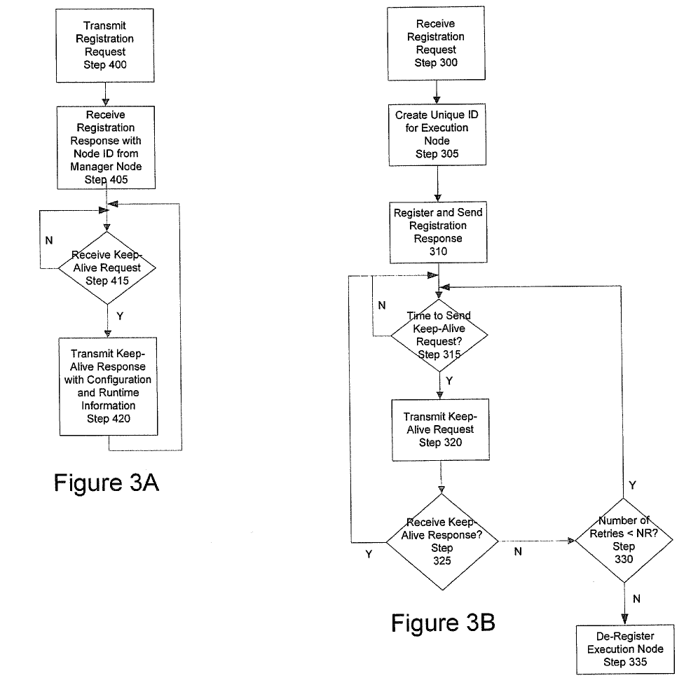

FIG. 2 illustrates examples of signaling call flows between the manager node 20 and execution nodes 10. The message flow in FIG. 2 is divided into three sections: registration and monitoring, monitoring and function activation; and status-update and operation command. Each of these sections will be described in detail with respect to FIGS. 3A-5B. A secure link and reliable transport protocol are used for communication between the execution node 10 and the manager node 20. To support these properties, existing mechanisms and protocols for authentication, data security and reliable transport can be used. These protocols will not be described in detail herein.

The execution node 10 uses a registration request 200 to register itself with the manager node 20. During registration the execution node 10 provides its information (i.e., Node Information) to the manager node 20. The manager node 20 assigns an identifier for the execution node 10, the assigned will be described in detail later. After processing this request, the manager node 20 sends back a registration response 205 which contains a result code for the registration request 200. If this registration request has been granted, then the result code will be set to “success” otherwise to “failure”.

The manager node 20 periodically transmits a keep-alive request 210 to the execution nodes 10. The keep-alive request 210 is used by the manager node to check the status of the managed execution nodes 10. This keep-alive message 210 must at least contain the Node Information, as well as Function Information. The Function ID is optional. The Node ID which is assigned by the manager node 20 is included in the keep-alive request 210 for tracking and confirmation. The execution node 10 responds to the keep-alive request 210 with a keep-alive response 215. If the manager node 20 does not get a response to the keep-alive message 210 (i.e., a keep-alive response 215) with the execution node's status, after a pre-configured time (number of retries), it de-registers the execution node 10 because the execution node 10 might be down. If the manager node 20 has information about previous status from this execution node (e.g., 10₁) (including functions and sessions), the manager node 20 may decide to assign or move the functions and sessions to another execution node (e.g., 10₂).

The manager node 20 can also transmit an operation command request 220 including at least one instruction to the execution node 10 to instruct the execution node 10 to execute a specific action to a function or a session. This operation command request 220 can be based upon the current status of the execution nodes 10. The Node ID is included in the request. Each specific instruction will include its own message specific information. The manager node 20 can obtain specific information from a specified execution node (e.g. 10) using a “GET” command In addition to the Node ID, the GET command includes at least a Function ID, and list of options. The Function ID is the identifier corresponding to the function which the desired specific information pertains to. The list of options corresponds to the requested information.

The manager node 20 can add a function to the execution node 10 using an “ADD” command. In addition to the Node ID, the ADD command includes at least Function Name, and Function ID. The Function name and Function ID corresponds to the added function. When the new function successfully boots up, the execution node 10 sends operation command response 225 to the manager node 20. The ADD command can activate a pre-installed functionality. Additionally, the ADD command can be used in conjunction with added capabilities to the execution node 10 where a new functionality is downloaded to the execution node 10. The new functionality can be downloaded from the manager node 20.

Similarly, the manager node 20 can delete a function on a specified execution node (e.g. 10₂) which causes the execution node 10 to terminate a running function using a “DELETE” command. In addition to the Node ID, the DELETE command includes the Function ID. When the termination is completed, the execution node 10 (e.g. 10₂) sends operation command response 225 to the manager node 20.

The manager node 20 can move a function on a specified execution node to another execution node 10 using a “MOVE_FUNCTION” command. Effectively, the MOVE_FUNCTION command acts as a combination of an ADD command and a DELETE command. The function is added to a new execution node 10 (e.g. 10₁). Nearly simultaneously the same function is deleted from the specified execution node (e.g. 10₂). The MOVE_FUNCTION command includes the source Node ID (i.e., specified execution node), the destination Node ID (i.e., the new execution node) and the Function ID. The specified execution node transmits the status information corresponding to the related function to the new execution node. Alternatively, the manager node 20 can transmit the status information to the new execution node.

Instead of moving a function to a new node, the function can be copied to at least one other execution node (e.g. from 10₁-10₂) using a “COPY” command. The COPY command is similar to the ADD command, however, the status information on the related function is transmitted to the new execution node. The specified execution node transmits the status information corresponding to the related function to the new execution node. Alternatively, the manager node 20 can transmit the status information to the new execution node. The COPY command includes the source Node ID (i.e., specified execution node), the destination Node ID (i.e., the new execution node) and the Function ID. This operation is used for example to duplicate a function in another execution node.

The manager node 20 can move an entire session to another execution node (e.g. from 10₁-10₂) using a “MOVE_SESSION” command, e.g., the source execution node is instruction to move specified sessions to a target or destination execution node (e.g., 10₁-10₂). When a session is moved, the function associated with the session may or may not be moved. If a MOVE_SESSION command is combined with another command such as, but not limited to, MOVE_FUNCTION, the function can also be moved. A session can be moved to another execution node 10 in order to reduce the load on an execution node 10. In this case, the MOVE_SESSION command can be independently used from the other commands. Alternatively, when functions are added, copied or moved, the MOVE_SESSION command can be used after the functions are activated. The MOVE_SESSION re-allocates the session based upon runtime information received by the manager node 20. The MOVE_SESSION command includes Source Node ID, Destination Node ID, and Session Information (i.e., session identifier) that corresponds to the specified session for movement. A session is separately identified from the functions that are active for the session. Like a Function ID for a function, a Session ID is used to identify a session. Functions and sessions can be uniquely identified and manipulated by the manager node 20 regardless of the hardware units that are providing the tangible resources. Alternatively, the MOVE_SESSION command can include a Function ID. If the MOVE_SESSION command includes a Function ID, all sessions related to the function are the targeted for the movement.

The execution nodes 10 can also send status-update 230 to the manager node 10 to notify the manager node 20 of its runtime or operational status including capacity and load. This status-update 230 contains the Node ID, Function ID and Function Information. Additionally, the status-update 230 can also include node information. Upon receipt of the status-update 230, the manager node 20 will transmit an ACK 235. Either the execution node 10 or manager node 20 can use a de-registration request 250 to cause the execution node 10 to de-register. The execution node 10 transmits the de-registration request 250 to de-register itself from the manager node 20. Additionally, the manager node 20 can also send the de-registration request 250 to the execution node 10 to force its de-registration. The de-registration request 250 includes a specified Node ID and the instruction. Upon receipt of De-registration request 250, the manager node 20 will likely move active sessions or function(s) handled by the execution node to another execution node to maintain an active session. Once the migration process has been completed, the manager node 205 will send a de-registration response 255. The de-registration response 255 will include a response code.

Each response or ACK 235 includes the requested information and/or status (result) code (success or failure). The Result Code can contain the following value: Success, Failed, Insufficient resources, Administratively prohibited and Status unknown. The ACK 235 additionally includes Node ID, Function ID and Running Status. The Operation Command Response 225 for the MOVE_FUNCTION command, COPY command or MOVE_SESSION command additionally includes both the source and destination node ID.

An “Error” 240 message is an asynchronous message that can be initiated by either the manager node 20 or the execution node 10 to notify the peer of an error condition. This error message 240 is not related to for example packet loss or congestion in the network. Rather, the error message 240 relates to an error condition on the execution node (e.g., 10₁) such as, but not limited to, resource exhaustion. The execution node (e.g., 10₁) reports the status to the manager node 20 with this error message. The error message 240 will indicate the type of error, e.g., overload CPU capacity. Upon receipt, the manager node 20 sends an ACK 235 to the execution node (e.g., 10₁). The manager node 20 will likely move the function(s) and/or sessions running on the execution node (e.g., 10₁). If the execution node (e.g., 10₁) doesn't receive an ACK 235 from the manager node, it will retry for a pre-configured certain number.

Each of the three message flow sections depicted in FIG. 2 will now be described with respect to FIGS. 3A-5B. FIGS. 3A and 3B illustrate flow charts for the registration of a execution node 10 with the manager node 20 in accordance with the invention. FIGS. 3A and 3B also illustrate the flow charts for the initial monitoring of the newly registered execution node 10 by the manager node 20. FIG. 3A illustrates the steps performed by the execution nodes 10 and FIG. 3B illustrates the steps performed by the manager node 20. The registration of execution nodes 10, monitoring the execution nodes and moving sessions and functions as illustrated in FIGS. 3A-5B enabling services continuity and mobility in the virtualized telecom infrastructure that may reside in a cloud environment in accordance with the invention. For purposes of the description, the functions of both the execution node 10 and the manager node 20 will be described together.

When the execution node 10 boots up, it registers itself with the manager node 20 by sending the registration request 200 at step 400. If the network address, such as, but not limited to, an IP address of the manager node 20 is not known, the execution node 10 obtains the network address (and port information) from an Information Server 25. At step 300, the manager node 20 receives the registration request 200. At step 305, the manager node 20 creates a unique Node ID for the execution node 10. For example during registration the execution node 10 may send its MAC address of the physical hardware as the identifier of the node. The manager node 20 can use the MAC address to generate a Node ID or retrieve an IP address for the execution node 10 from the Information Server 25. For example, the generation of the Node ID can be based on hash function using the MAC address as the input. Alternatively, the generation could be done by a dynamic approach. In this case, if the execution node 10 fails or crashes, the Node ID would not be recovered.

At step 310, the manager node 20 registers the execution node 10 by adding the information regarding the execution node 10 into a management table (registry table) indexed by Node ID. The management table and registry table are used interchangeably. The Node ID is transmitted to the execution node 10 via the registration response 205 (also at step 310). At step 405, the execution node 10 receives the Node ID from the manager node 20 via the registration response 205. The execution node 10 uses this node ID for all subsequent communication with the manager node 20.

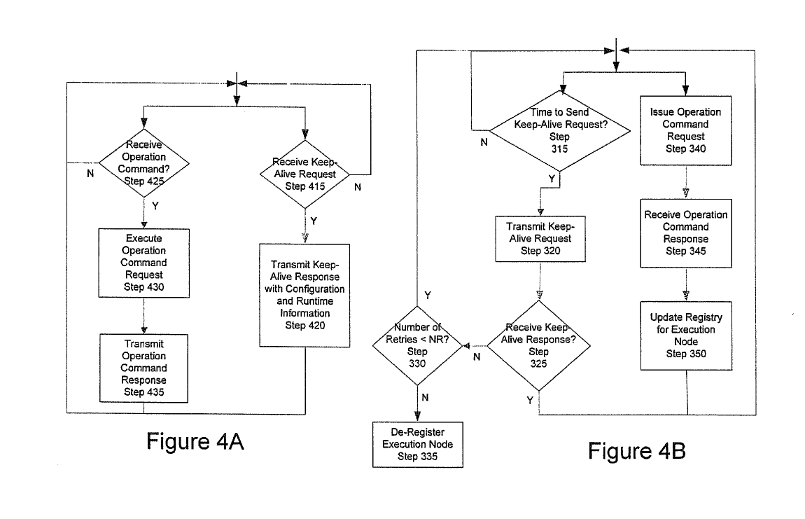

After the execution node 10 receives the Node ID, the execution node 10 can initiate any functions that are required by the manager node 20. Adding of a function will be described later with respect to FIGS. 4A and 4B.

Periodically, the manager node 20 polls each execution node 10 in the management table for their status by sending the Keep-Alive request 210. The interval time can be set as a configurable parameter. The time interval can be the same for each execution node 10. Alternatively, the time interval can dynamically vary between execution nodes 10 based upon runtime information received via the keep-alive response 215 or status-update 230. When the execution node 10 is registered in the manager node 20 (in the management table), the manager node 20 starts a timer. At step 315, the manager node 20 determines if the timer expires. If the timer expires (“Y” at step 315), the manager node 20 transmits the keep-alive request 210 to the execution node 10 at step 320. If the timer has not expired, the manager node 20 waits at step 315.

At step 415, the execution node 10 determines if the keep-alive request 210 has been received. If the keep-alive message 210 is received (“Y” at step 415), the execution node 10 transmits a keep-alive response 215 205 with the status information at step 420.

The status information can include both pre-configuration information and runtime information. Runtime information includes information related to the CPU, memory/storage, network usages and functional running status. For example, runtime information includes, but is not limited to, active function name (e.g., P-CSCF, HSS, PCRF, MME, S-GW or P-GW), processing capability, current and average load, required and available memory, network parameters (total bandwidth, current/average used bandwidth), running status (e.g., starting, running, terminating, or unknown), function dependent information (e.g., number of active session, processing status, number of registered UEs, average time for processing messages) and running status (e.g., Starting, Running, Terminating or Unknown). The session information can be session information for a SIP such as SIP URI (e.g., sip:alice@example.com), contact address (IPv4 or IPv6 format), number of sessions (e.g., 1000) and ratio to the whole sessions (e.g., 35%). The ratio of the whole sessions can be used as a trigger for the manager node 20 to move sessions to another function running in a different execution node 10 in order to reduce the load.

The preconfigured information include network address for the execution node, port, Node ID assigned by the manager node 20 to the execution node 10, installed functionality for the execution node, boot up time and other capabilities.

If the keep-alive request 210 is not received (“N” at step 415), the execution node 10 waits, i.e., remains at step 415.

At step 325, the manager node 20 determines if a Keep-alive response 215 for the keep-alive request 210 was received. When the manager node 20 transmits the keep-alive message 210, the manager node sets a wait timer. The wait timer is uses as a watch-dog timer, to de-register or purge execution nodes 10 that do not respond within a period of time. The wait timer acts as a delay between two consecutive retries. For example, if the wait timer is set to 2 seconds, then the manager node will wait 2 seconds before retrying the keep-alive request. If the keep-alive response 215 is not received (“N” at step 325), prior to retrying to sent the keep-alive request 210, the manager node increments a counter. The manager node 20 only retransmits the keep-alive request 210 for a preconfigured number of times (NR). For example, if NR=3, then the manager node 20 will consider the execution node 10 down after three retries. At step 330, the manager node compares NR with the current number of retries. The current number of retries is indicated by the counter. If the current number of retries is less than NR, the manager node re-transmits the keep-alive request 210 (e.g., returns to step 315). If the current number of retries equals NR, the manager node 20 de-registers the execution node at step 335. The manager node also removes the execution node from the registry table. FIGS. 4A and 4B illustrate flow charts for the monitoring and initial activation of functions in the execution node. FIG. 4A illustrates a flow chart for the execution node 10 and FIG. 4B illustrates steps for the manager node 20. As illustrated, the monitoring and initial activation of function occurs in parallel. When an execution node 10 registers with the manager node 20, functions can be simultaneously activated. Alternatively, the manager node 20 can activate the functions as needed. Since the activation of functions and monitoring of the execution nodes 10 occur in parallel, steps 315-335 and 415-420 are also depicted in FIGS. 4A and 4B. These steps have been previously described with respect to FIGS. 3A and 3B and will not be described in detail again.

When the manager node 20 needs to activate a function on the execution node, the manager node issues an operation command request 220 at step 340. For adding a function, the operation command request 220 includes the ADD instruction. Once the execution node 10 boots up, the execution node 10 waits for an operation command request 220 (step 425) and/or a keep-alive request 210 (step 415). If an operation command request 220 is received at step 425, the execution node 10 examines the operation command request 220 for an instruction and then executes the operation command request at step 430. For example, the operation command request 220 included an ADD instruction; the function identified in the ADD instruction would be activated. If the function is not pre-installed, the execution node will download the function.

Once the function is activated and running, the execution node replies with an operation command response 225 (at step 435) having a result code indicating a success. If the activation fails, the operation command response 225 will indicate that the activation failed (e.g., Result code=failure). The operation command response will also include pre-configuration information and runtime information.

When the operation command response 225 is received, the manager node 20 updates the management table with the status information in the operation command response 225 for the corresponding execution node at step 350 including both pre-configuration information and runtime information. The pre-configuration information can change if the new function is added to the execution node including remotely installing the functionality (as opposed to enabling a functionality that was pre-installed).

After the management table has been updated, the manager node 20 can determines if a change is needed for the functionality of the execution node 10. The change is determined using the status information in the management table.

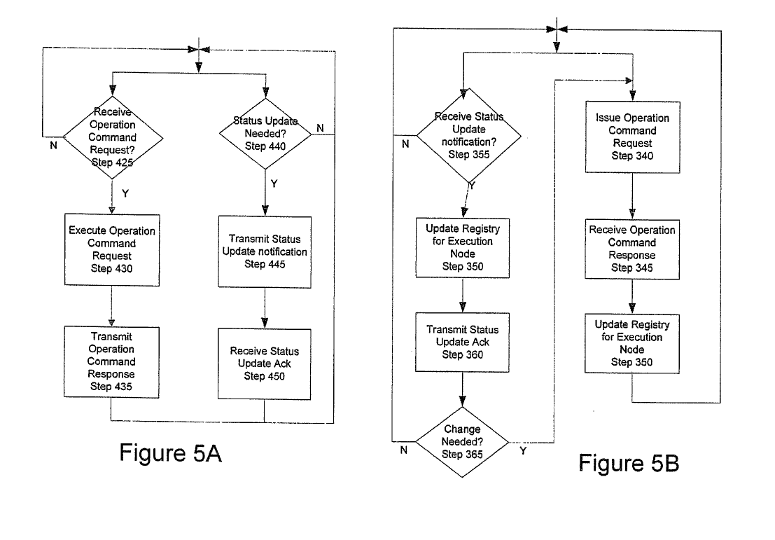

The execution node 10 can also report its status information to the manager node 20, as needed. For example, if the execution node is running multiple sessions. FIGS. 5A and 5B illustrate flow charts for runtime operation of the execution nodes 10 and the manager node 20. The monitoring of the execution nodes 20 as depicted in FIGS. 4A and 4B also occur in parallel with the steps depicted in FIGS. 5A and 5B, however, for illustrative purposes, those steps were omitted.

At step 440, the execution node 10 determines if there is a need to transmit a status update 230. This determination can be based upon pre-configured capacity parameters and the current runtime information. For example, if the current number of activate sessions exceeds a pre-configured number, e.g., 10, the execution node 10 will transmit the status update 230. If the execution node 10 determines the no status update 230 should be transmitted, the node waits for other commands or requests from the manager node 20. If a status update is needed (“Y” at step 440), the execution node 10 transmits the status update 230 to the manager node.

The manager node continuously checks for status updates 230 from each of the execution nodes. If no status update is received, the manager node 20 continues to wait or execute other functionality such as, but not limited to issuing operation command requests 220 (step 340) or keep-alive requests 210 (step 320). If a status update 230 is received, the manager node updates the registry table for the execution node at step 350 with the status information including the runtime information. When the registry table is updated, the manager nod transmits an ACK at step 360. After the management table has been updated, the manager node 20 can determines if a change is needed for the functionality of the execution node 10 at step 365. The change is determined using the status information in the management table. For example, for load balancing, the manager node 20 can issue a COPY command to the execution node 10 to copy the function and add the function to another execution node. The execution nodes 10 will communicate with each other to move functions between the nodes (as part of step 430).

If there are changes needed (“Y” at step 365), the manager node 20 transmits the operation command request 220 including the desired instruction to the execution node 10 to instruct the execution node 10 to execute the action at step 340. Upon receipt of the operation message 220 (“Y” at step 425), the execution node 10 executes the instruction at step 430 and then upon completion, transmits the operation command response 2251f no change is needed (“N” at step 365), the manager node executes other functionality such as receiving status updates (step 355), transmitting keep-alive requests (step 320), etc.

If the execution node 10 goes out of the coverage area or the domain controlled by the manager node 20 or if it is going to be shut down it sends the de-registration request 250 to the manager node 20. When the manager node 20 receives the de-registration request 250, it removes the execution node 10 from the management table (not shown in the figures). Such de-registration request 250 doesn't include unpredictable failure of the execution node 10. The Error (message) 240 is asynchronously sent by either node to notify the other peer when an erroneous event happens (e.g., when the manager node 20 becomes unable to perform the management tasks). As noted above, the manager node 20 can, as needed, transmit a GET message to the execution node 10 to obtain specified information. The execution node 10 receives this GET message and responds accordingly.

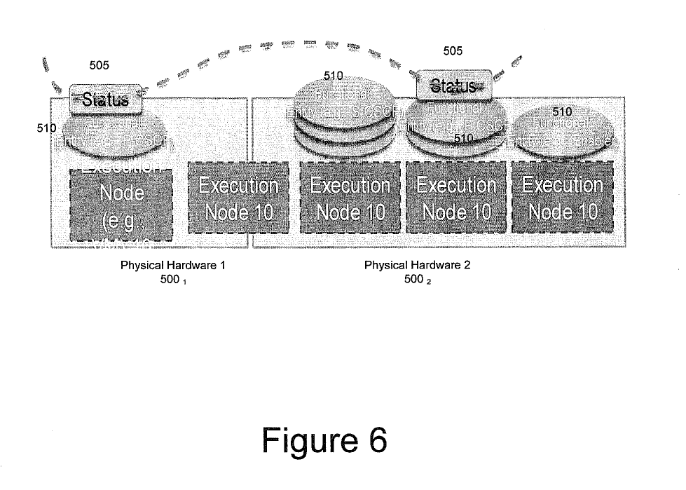

FIG. 6 illustrates an example of a function moving between two different physical hardware devices 500 in a virtual environment. As depicted in FIG. 6, there are two different physical hardwares (1 and 2)(referenced as 500₁ and 500₂, respectively). Each physical hardware 500 is capable of being multiple execution nodes 10, where each execution node 10 can execute a function (depicted as Functional entities 510). For example, physical hardware 2 500₂ is capable of executing functional entities S-CSCF, P-CSCF, and an enabler. At any given time, one or more of these functions can be activated. As depicted in FIG. 6, the functional entity 510 in physical hardware 1 500₁ is moved into physical hardware 2 500₂. When the functional entity, i.e., function is moved, the status 505 is also moved. The movement of the status 505 is depicted by the dashed line between a first functional entity in the physical hardware 1 500₁ and a second functional entity in physical hardware 2 500₂. The status is move to maintain consistency of the information to continue the session in the new physical hardware. In FIG. 6, the function entity being moved is a P-CSCF for an IMS session. Additionally, an execution node 10 can be performed on two different physical hardwares 500₁ and 500₂. Functions run on the execution nodes 10 and one or more session(s) may be established with the corresponding status information; more than one session can be run on the same function.

The movement must be transparent to the service user meaning that the on-going service must be continued seamlessly and the existing protocols and interfaces should not be affected by this capability.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as “modules” or “system.”

Various aspects of the present disclosure may be embodied as a program, software, or computer instructions embodied or stored in a computer or machine usable or readable medium, which causes the computer or machine to perform the steps of the method when executed on the computer, processor, and/or machine. A computer readable medium, tangibly embodying a program of instructions executable by the machine to perform various functionalities and methods described in the present disclosure is also provided.

The nodes, system and method of the present disclosure may be implemented and run on a general-purpose computer or special-purpose computer system. The computer system may be any type of known or will be known systems such as, but not limited to, a virtual computer system and may typically include a processor, memory device, a storage device, input/output devices, internal buses, and/or a communications interface for communicating with other computer systems in conjunction with communication hardware and software, etc.

The computer readable medium could be a computer readable storage medium or a computer readable signal medium. Regarding a computer readable storage medium, it may be, for example, a magnetic, optical, electronic, electromagnetic, infrared, or semiconductor system, apparatus, or device, or any suitable combination of the foregoing; however, the computer readable storage medium is not limited to these examples. Additional particular examples of the computer readable storage medium can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an electrical connection having one or more wires, an optical fiber, an optical storage device, or any appropriate combination of the foregoing; however, the computer readable storage medium is also not limited to these examples. Any tangible medium that can contain, or store a program for use by or in connection with an instruction execution system, apparatus, or device could be a computer readable storage medium.

The terms “nodes” and “network” as may be used in the present application may include a variety of combinations of fixed and/or portable computer hardware, software, peripherals, and storage devices. The system may include a plurality of individual components that are networked or otherwise linked to perform collaboratively, or may include one or more stand-alone components. The hardware and software components of the computer system of the present application may include and may be included within fixed and portable devices such as desktop, laptop, and/or server, and network of servers (cloud). A module may be a component of a device, software, program, or system that implements some “functionality”, which can be embodied as software, hardware, firmware, electronic circuitry, or etc.

The above description provides illustrative examples and it should not be construed that the present invention is limited to these particular example. Thus, various changes and modifications may be effected by one skilled in the art without departing from the spirit or scope of the invention as defined in the appended claims.

What is claimed is:

1. A method for managing service continuity and mobility in a virtualized telecom system comprising:
receiving a registration request from an execution node;
registering the execution node for a specified function;
transmitting, periodically, a request for a status from the execution node;
de-registering the execution node if a response to the request for a status is not received within a variable period of time; and
transmitting a control message to the execution node.

2. The method for managing service continuity and mobility in a virtualized telecom system according to claim 1, wherein the control message includes an instruction to add a specified function to the execution node, the specified function being identified by an identifier.

3. The method for managing service continuity and mobility in a virtualized telecom system according to claim 1, wherein the control message includes an instruction to delete a specified function to the execution node, the specified function being identified by an identifier.

4. The method for managing service continuity and mobility in a virtualized telecom system according to claim 1, wherein the control message includes an instruction to move a specified function from the execution node to a second execution node, the specified function being identified by an identifier and the second execution node being identified by a node identifier, wherein status and runtime information corresponding to the specified function is transmitted from the execution node to the second execution node.

5. The method for managing service continuity and mobility in a virtualized telecom system according to claim 1, wherein the control message includes an instruction to move a specified session from the execution node to a second execution node, the specified session being identified by a session identifier.

6. The method for managing service continuity and mobility in a virtualized telecom system according to claim 1, further comprising receiving an acknowledgement when the execution node execute the control message.

7. The method for managing service continuity and mobility in a virtualized telecom system according to claim 1, further comprising receiving message from the execution node when the execution node completes a function included in the control message.

8. The method for managing service continuity and mobility in a virtualized telecom system according to claim 4, wherein the instruction to move a specified function comprises two instructions, a first of the two instructions being a delete instruction to delete the specified function from the execution node, and the second of the two instructions being an add instruction to add the specified function to the second execution node.

9. The method for managing service continuity and mobility in a virtualized telecom system according to claim 5, wherein session dialog corresponding to the moved session is moved to the second execution node.

10. The method for managing service continuity and mobility in a virtualized telecom system according to claim 1, further comprising receiving configuration and runtime information from the execution node in response to the request for a status.

11. A method for executing a function on an execution node in a virtualized telecom system comprising:
obtaining a network address for a management node;
transmitting a registration request from a execution node;
receiving a unique functional node identifier from the management node;
receiving a control message including at least one instruction from the management node; and
executing the at least one instruction.

12. The method for executing a function on an execution node in a virtualized telecom system according to claim 11, further comprising transmitting configuration and runtime information from the execution node in response to the request for a status.

13. The method for executing a function on an execution node in a virtualized telecom system according to claim 11, wherein the at least one instruction is selected from a group consisting of: adding a specified function, deleting a specified function, moving a specified function to a second execution node, copying a specified function to a second execution node, moving a session, and providing a specified configuration or runtime information to the management node.

14. The method for executing a function on an execution node in a virtualized telecom system according to claim 11, wherein if the at least one instruction is moving a specified function and copying a specified function, real time runtime information and status information is transmitted to the second execution node.

15. The method for executing a function on an execution node in a virtualized telecom system according to claim 11, wherein if the at least one instruction is moving a session, real time dialog information is transmitted to the second execution node.

16. A virtualized telecom system comprising:
a plurality of execution nodes each configured to execute a network function by registering; and a manager node for registering each of the plurality of execution nodes, assigning a node identifier (Node ID) to each of the plurality of execution nodes, periodically polling each of the plurality of execution nodes for a status, and issuing control instructions to each of the plurality of execution nodes based upon the status of a respective execution node, where each of the plurality of execution node responds to the polling by transmitting its status to the manager node, the status including runtime information and pre-configuration information.

17. A computer readable storage medium having a program for causing a computer to execute a method for managing service continuity and mobility in a virtualized telecom system comprising:
receiving a registration request from a execution node;
registering the execution node for a specified function;
transmitting, periodically, a request for a status from the execution node;
de-registering the execution node if a response to the request for a status is not received within a variable period of time; and
transmitting a control message to the execution node.

18. A computer readable storage medium having a program for causing a computer to execute a executing a function on an execution node in a virtualized telecom system comprising:
obtaining a network address for a management node;
transmitting a registration request from a execution node;
receiving a unique functional node identifier from the management node;
receiving a control message including at least one instruction from the management node; and
executing the at least one instruction.
